(19) United States
(12) Patent Application Publication
(10) Pub. No.: US 2012/0127058 A1
(43) Pub. Date: May 24, 2012

(54) ANTENNA FOR PORTABLE DEVICE

(75) Inventors: TZUN-YAN SU, Taoyuan County (TW); CHENG-I CHANG, Taoyuan County (TW); YU-TING CHEN, Taoyuan County (TW)

(73) Assignee: FOXCONN COMMUNICATION TECHNOLOGY CORP., Taoyuan County (TW)

(21) Appl. No.: 13/037,484

(22) Filed: Mar. 1, 2011

(30) Foreign Application Priority Data
Nov. 18, 2010 (TW) 99139637

(51) Int. Cl. H01Q 9/42

(52) U.S. Cl. 343/900

(57) ABSTRACT

The disclosure provides an antenna used for a portable device. The antenna includes a feed portion, a first radiating portion, and a second radiating portion. The first radiating portion connects with the feed portion. The matching portion connects between the first radiating portion and the second radiating portion. The first radiating portion includes an initial end connecting with the feed portion, and a final end connecting with the matching portion. The second radiating portion extends from the matching portion and extends toward the initial end.

### BACKGROUND

1. Technical Field

The present disclosure relates to an antenna used for a portable device.

2. Description of Related Art

Portable devices such as mobile phones, personal digital assistants (PDA) and laptop computers are widely used. Antennas are installed in such portable devices to receive/send wireless signals. Generally, the antennas may receive/send wireless signals of different frequencies (e.g., DCS1800, PCS1900, UMTS2100), requiring that the antennas be multiband antennas.

However, most conventional multiband antennas include different electric conduction paths configured to receive/send wireless signals, such that volume of these antennas cannot be reduced.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a perspective view of an exemplary embodiment of an antenna.

FIG. 2 is an inverted view of FIG. 1.

FIG. 3 is a measurement diagram of voltage standing wave ratio (VSWR) of the antenna of FIG. 1.

FIG. 4 is a perspective view of another exemplary embodiment of an antenna.

### DETAILED DESCRIPTION

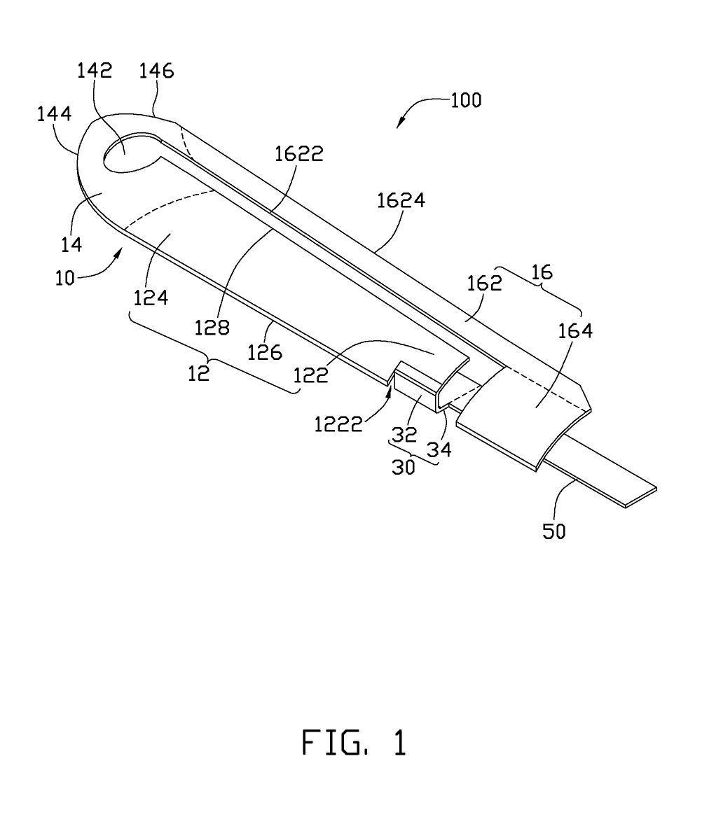

FIG. 1 is a perspective view of an exemplary embodiment of an antenna 100. The antenna 100 is installed in a portable device (not shown) to receive/send wireless signals. The portable device may be a mobile phone, a personal digital assistant (PDA), or a laptop computer, for example. In the exemplary embodiment, the portable device is a mobile phone. The antenna 100 includes a main body 10, a feed portion 30, and a ground portion 50. In the exemplary embodiment, the antenna 100 is a planar inverted-F antenna (PIFA).

The main body 10 includes a first radiating portion 12, a matching portion 14, and a second radiating portion 16. The first radiating portion 12 is arcuate and includes an initial end 122, a final end 124, a first side 126, and a second side 128. The initial end 122 is wider than the final end 124. The second side 128 is opposite to the first side 126. The initial end 122 is provided with a gap 1222 abutting the first side 126.

An opening 142 is defined on the matching portion 14. The matching portion 14 connects with the final end 124 of the first radiating portion 12, and encircles the opening 142 to connect the second radiating portion 16. The matching portion 14 includes a first arc 144 and a second arc 146 opposite to the first arc 144. The second radiating portion 16 extends from the matching portion 14 and extends toward the initial end 122 of the first radiating portion 12.

The second radiating portion 16 includes a first connection end 162 and a second connection end 164. The first connection end 162 is longer than the first radiating portion 12 and narrower than the first radiating portion 12. The first connection end 162 connects with the matching portion 14. The first connection end 162 further includes an internal side 1622 and an external side 1624. The internal side 1622 connects with the opening 142 of the matching portion 14 and is parallel to the second side 128 of the first radiating portion 12. The external side 1624 connects with the second arc 146 of the matching portion 14. One side of the second connection end 164 connects with the first connection end 162. Other side of the second connection end 164 is aligned with the first side 126 of the first radiating portion 12.

The feed portion 30 is rectangular and electrically connects with a signal transmissive end of a printed circuit board (PCB) (not shown) of the portable device to feed the radio frequency signals. The feed portion 30 includes a connection end 32 and a transition end 34. One side of the connection end 32 connects with the initial end 122 of the first radiating portion 12. Other side of the connection end 32 connects with the transition end 34. One side of the transition end 34 is aligned with the second side 128 of the first radiating portion 12.

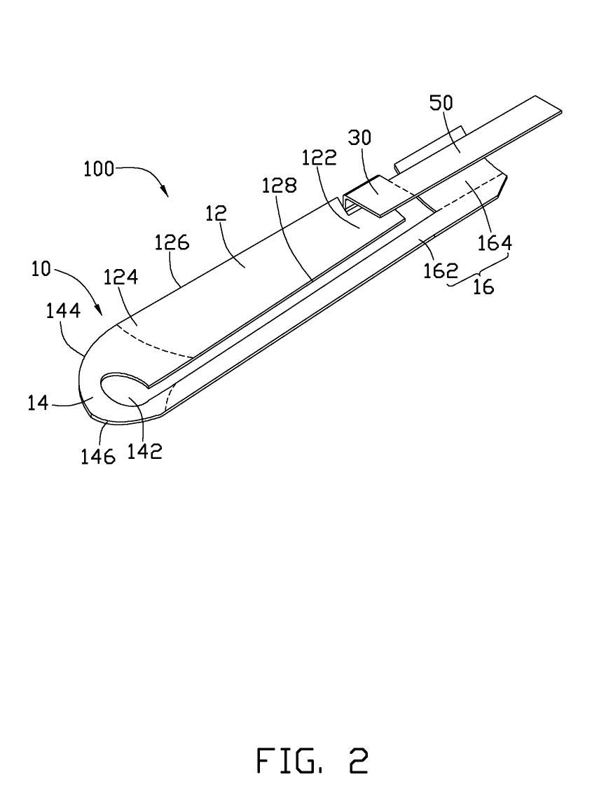

FIG. 2 is an inverted view of FIG. 1. The ground portion 50 is rectangular and connects with the transition end 34 of the feed portion 30. The ground portion 50 further extends away from the first radiating portion 12.

The first radiating portion 12, the matching portion 14, and the second radiating portion 16 jointly form a single electric conduction path to generate two operating bands of the antenna 100. The radio frequency signals feed in the feed portion 30, and then generate two current paths of the two operating bands at the single electric conduction path. One current path is from the feed portion 30 to the first radiating portion 12. The other current path is from the feed portion 30, through the first radiating portion 12 and the matching portion 14, to the second radiating portion 16. The two current paths share the first radiating portion 12, such that the volume of the antenna 100 can be reduced.

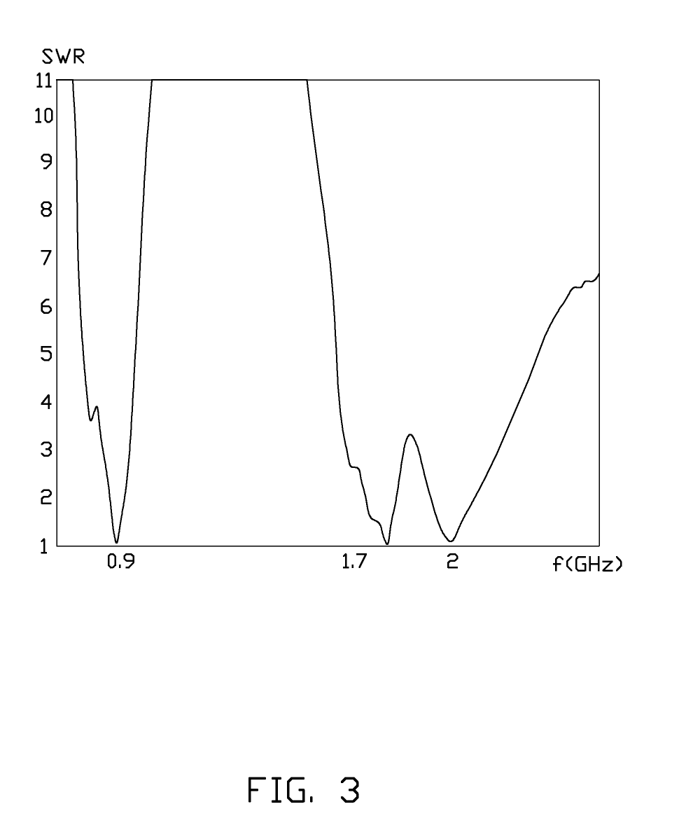

FIG. 3 is a measurement diagram of voltage standing wave ratio (VSWR) of the antenna 100 of FIG. 1. The antenna 100 has good performance when operating at bandwidths of about 824 MHz to 960 MHz and bandwidths of about 1.71 GHz to 2.17 GHz.

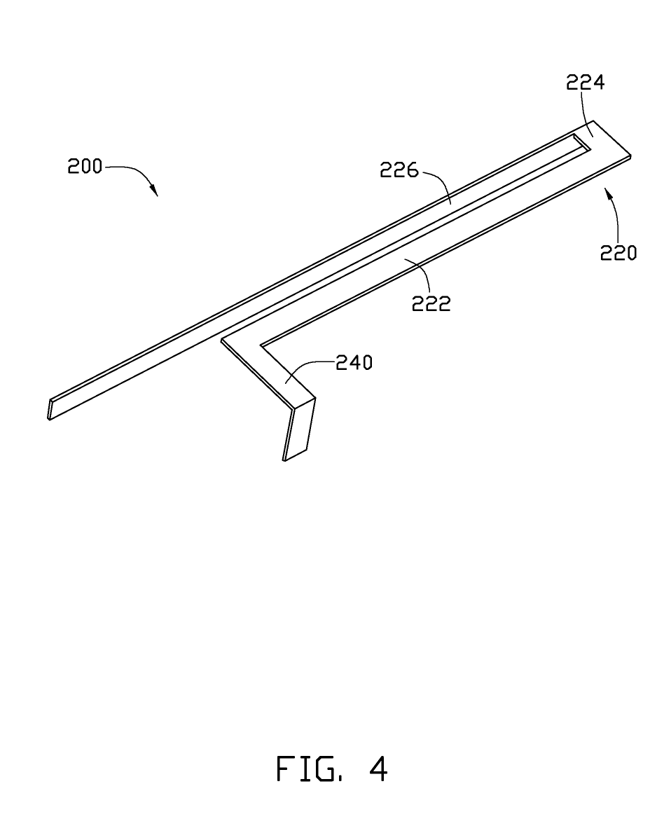

FIG. 4 is a perspective view of another exemplary embodiment of an antenna 200. In the exemplary embodiment, the antenna 200 is a monopole antenna and includes a main body 220 and a feed portion 240. The feed portion 240 connects with the main body 220. The main body 220 includes a first radiating portion 222, a matching portion 224, and a second radiating portion 226. The first radiating portion 222 is rectangular. The matching portion 224 and the first radiating portion 222 are on the same plane. The second radiating portion 226 is rectangular and longer than the first radiating portion 222. The second radiating portion 226 connects with the matching portion 224 and is perpendicular to the matching portion 224.

The first radiating portion 222, the matching portion 224, and the second radiating portion 226 jointly form a single electric conduction path to generate two operating bands of the antenna 200. The radio frequency signals feed to the feed portion 240, and then generate two current paths of the two operating bands at the single electric conduction path. One current path is from the feed portion 240 to the first radiating portion 222. Other current path is from the feed portion 240, through the first radiating portion 222 and the matching portion 224, to the second radiating portion 226. The two current paths share the first radiating portion 222, such that the volume of the antenna 200 can be reduced.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An antenna, comprising:
a feed portion;
a first radiating portion connected with the feed portion;
a second radiating portion; and
a matching portion connected between the first radiating portion and the second radiating portion;
wherein the first radiating portion comprises an initial end connecting with the feed portion, and a final end connecting with the matching portion;
wherein the second radiating portion extends from the matching portion and extends toward the initial end.

2. The antenna of claim 1, wherein the first radiating portion comprises:
a first side; and
a second side opposite to the first side;
wherein the initial end is provided with a gap abutting the first side.

3. The antenna of claim 2, wherein an opening is defined on the matching portion; the matching portion connects with the final end of the first radiating portion and encircles the opening to connect the second radiating portion.

4. The antenna of claim 3, wherein the matching portion comprises a first arc and a second arc opposite to the first arc.

5. The antenna of claim 4, wherein the second radiating portion comprises:
a first connection end connecting with the matching portion; and
a second connection end connecting with the first connection end.

6. The antenna of claim 5, wherein the second radiating portion comprises:
an internal side connecting with the opening of the matching portion and parallel to the second side of the first radiating portion; and
an external side connecting with the second arc of the matching portion.

7. The antenna of claim 5, wherein the second connection end of the second radiating portion is aligned with the first side of the first radiating portion.

8. The antenna of claim 1, further comprises a ground portion connecting with the feed portion, the ground portion extends away from the first radiating portion.

9. The antenna of claim 1, wherein the antenna is a planar inverted-F antenna (PIFA).

10. The antenna of claim 1, wherein the antenna is a monopole antenna.
